(19) United States
(12) Patent Application Publication
(10) Pub. No.: US 2018/0065456 A1
(43) Pub. Date: Mar. 8, 2018

(54) Apparatus for Automatically Covering an Automobile and Method for Using the Same

(71) Applicant: David R. Sun, Placentia, CA (US)

(72) Inventor: David R. Sun, Placentia, CA (US)

(21) Appl. No.: 15/696,895

(22) Filed: Sep. 6, 2017

Related U.S. Application Data
(60) Provisional application No. 62/384,332, filed on Sep. 7, 2016.

(51) Int. Cl. B60J 11/04

(52) U.S. Cl. CPC B60J 11/04

(57) ABSTRACT

An apparatus and method for disposing a cover over an automobile. The apparatus is placed on the highest portion of a vehicle and then activated by either actuating an app on a mobile device or by actuating the apparatus itself. The apparatus then raises a shell and exposes a cover that is disposed about a rotating body. A motor disposed within the apparatus then begins to spin the rotating body which expands the cover out over the vehicle. Once fully deployed, the user may secure the cover to the vehicle. To retract the cover, the user releases the cover from the vehicle and then activates the apparatus to spin the rotating body in the opposing direction which draws the cover back into the apparatus. The apparatus may be powered by a plurality of batteries or recharged by the sun via a solar panel disposed within the surface of the apparatus.

### RELATED APPLICATIONS

The present application is a non-provisional application of U.S. application Ser. No. 62/384,332, filed on Sep. 7, 2016, which is incorporated herein by reference and to which priority is claimed pursuant to 35 USC 119.

### FIELD OF THE TECHNOLOGY

The invention relates to the field an automated covering apparatus, specifically an apparatus which may automatically deploy and cover an automobile after the automobile has been parked.

### DESCRIPTION OF THE PRIOR ART

The level of car ownership among the general population across the globe has been dramatically increasing over the past several decades. With an ever increasing proportion of car owners there is also an increased demand by those owners to protect their property. For automobiles, this traditionally has taken the form of a cover made of canvas or other suitable material which must be manually disposed over an automobile and the secured to the automobile using ties, ropes, bungie cords, or other temporary coupling means. Additionally, if the cover has been disposed on an automobile for an extended amount of time, it can become extremely dirty and thus easily soil the clothes of a user who needs to be in close proximity to both the cover and the automobile in order to effectively remove the cover from the automobile. Additionally, even once the cover has been removed, it is still needs to be stored which can become difficult when the user does not have sufficient storage space or is a hurry and needs to save time.

What is needed therefore is an apparatus and method which avoids the problem of manually covering and uncovering an automobile. The apparatus and method should allow a person to easily and quickly deploy and retract a cover over an automobile while also conveniently storing the apparatus when not in use.

### BRIEF SUMMARY

The present invention provides a novel automatic automobile covering apparatus. The present invention is simple and convenient to use and is simple to manufacture.

The present invention comprises a base, a rotating cylinder, a cover fixed to the rotating cylinder/drum on the base, a rotating barrel lifter, and a lifting rod coupled to a shell that is disposed over the base. Also coupled to the base are a plurality of suction cups. Briefly, the apparatus activates the lifting rod which in turn raises up the shell, exposing the cover which is disposed therein. The rotating cylinder is the activated which effectively throws or spins out the cover from the apparatus in a circular motion. When the user wishes to remove the cover, the drum rotates in a reverse direction which retracts the cover underneath the shell. The shell is then lowered back to the surface of the automobile by a lowering of the lifting rod.

The present invention provides several advantages from the covers found in the prior art. Specifically, using the present invention, only one person is needed to easily cover the automobile in a durable, weatherproof enclosure. Additionally, the present invention comprises a novel structure which is simple to manufacture and it is compact which allows the apparatus to be conveniently stored and is easily transported.

The invention includes an apparatus for covering a vehicle. The apparatus includes a base, a rotation body coupled to the base, and a lift rod coupled to the base. The apparatus further comprises both a motor and a cover coupled to the rotation body. Additionally, a shell is disposed over the base and coupled to the lift rod to provide an enclosure for the cover.

In one embodiment, the lift rod within the apparatus includes a rack spline. In this embodiment, the apparatus further includes a lift gear that is coupled to the motor and which is further engaged with the rack spline.

In a separate embodiment, the apparatus further includes a plurality of suction cups that are disposed on the base and configured to be removably adhered to a surface of the vehicle.

In yet another embodiment, the rotation body includes a rotating cylinder and a control system.

In another embodiment, the shell of the apparatus includes a solar panel disposed in a surface of the shell.

In a related embodiment, the shell of the apparatus includes a liquid crystal display panel disposed in a surface of the shell.

In another specific embodiment, the apparatus also includes a first gear coupled to the motor, a double gear engaged with the first gear, and a gear ring coupled to the double gear. In this embodiment, the cover is also coupled to the gear ring.

In another embodiment, the lift rod of the apparatus is a telescopic lift rod.

In another embodiment, the apparatus is further configured to be operated via a mobile device.

In yet another embodiment, the apparatus may also include a light coupled to the shell, and/or an alarm disposed on the shell.

The current invention further includes a method for automatically disposing a cover over a vehicle. The method includes removably coupling an apparatus onto the surface of a vehicle, wherein the apparatus has a cover disposed between a shell and a base of the apparatus, actuating the apparatus to raise the shell off of the base, and then rotating a rotation body disposed underneath the shell in a first direction, the rotation body being coupled to the cover. The rotation of the rotation body then disposes the cover over the surface of the vehicle. Next, the cover is secured in place over the vehicle.

In one embodiment, the method step of removably coupling an apparatus onto the surface of a vehicle includes removably adhering the apparatus to the surface of the vehicle via a plurality of suction cups.

In yet another embodiment, the method step of actuating the apparatus to raise the shell off of the base comprises activating a motor to raise a telescopic lift rod disposed between the shell and the base.

In yet another embodiment, the method step of actuating the apparatus to raise the shell off of the base comprises activating a motor that is engaged to a rack spline via a lift gear to raise the rack spline disposed between the shell and the base.

In another embodiment, the method also includes rotating the rotation body in a second direction, drawing the cover about the rotation body and retracting the cover underneath the shell, and actuating the apparatus to lower the shell onto the base.

In a further embodiment, the method step of actuating the apparatus to raise the shell off of the base and rotating a rotation body disposed underneath the shell in a first direction includes remotely sending an actuation command to the apparatus from a mobile device.

In another specific embodiment, the method includes recharging the apparatus via a solar panel disposed in a surface of the shell.

In a further embodiment, the method further includes emitting an audio or visual signal from the apparatus by remotely sending an actuation command to the apparatus from a mobile device.

In yet another embodiment, the method step of rotating a rotation body disposed underneath the shell in a first direction involves activating a motor to rotate a plurality of gears which in turn rotates a cover bracket coupled to the cover in the first direction.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of the automatic car covering apparatus of the current invention when the car covering apparatus is in a closed configuration.

FIG. 2 is a side cross sectional view of the automatic car covering apparatus seen in FIG. 1.

FIG. 3 is a side cross sectional view of the automatic car covering apparatus seen in FIG. 1 when the car covering apparatus is in an open configuration.

FIG. 4 is a side cross sectional view of an alternative embodiment of the automatic car covering apparatus seen in FIG. 1 comprising an alternative configuration for the motor and means for lifting the shell.

FIG. 5 is a side cross sectional view of an alternative embodiment of the automatic car covering apparatus seen in FIG. 1 comprising an alternative configuration for the motor and means for deploying the cover.

FIG. 6 is an illustrative depiction of a screen disposed on a mobile device used for controlling the car covering apparatus seen in FIG. 1.

FIG. 7 is an alternative illustrative depiction of a screen disposed on a mobile device used for controlling the car covering apparatus seen in FIG. 1.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

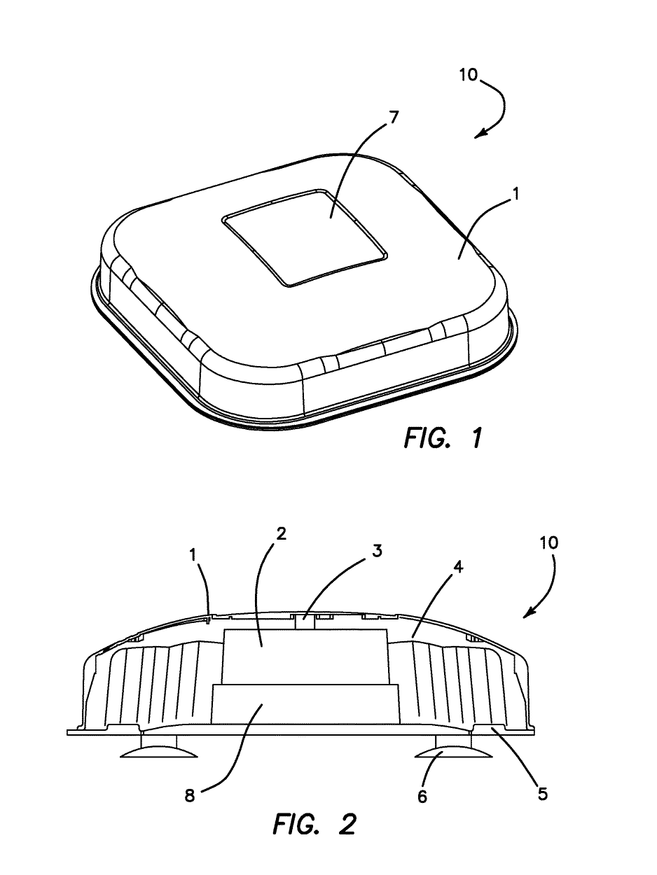

The current invention is an automated car cover apparatus and may be seen in FIGS. 1-3 and is generally denoted by reference numeral 10. The apparatus 10 comprises a shell 1 that, as seen in FIG. 1, is substantially square or rectangle shaped and is preferably comprised of plastic or plastic composites. Disposed over a substantial portion of the outer surface of the shell 1 is a solar panel 7 or other photo electric cell as is known in the art. Also disposed on the outside surface of the shell 1 is a light or other illumination means.

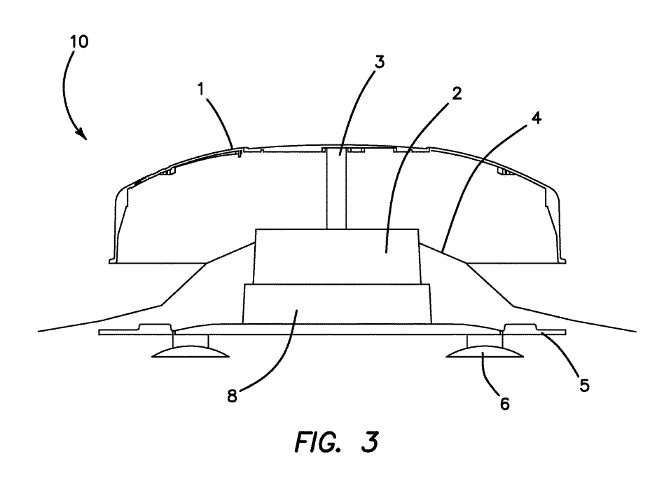

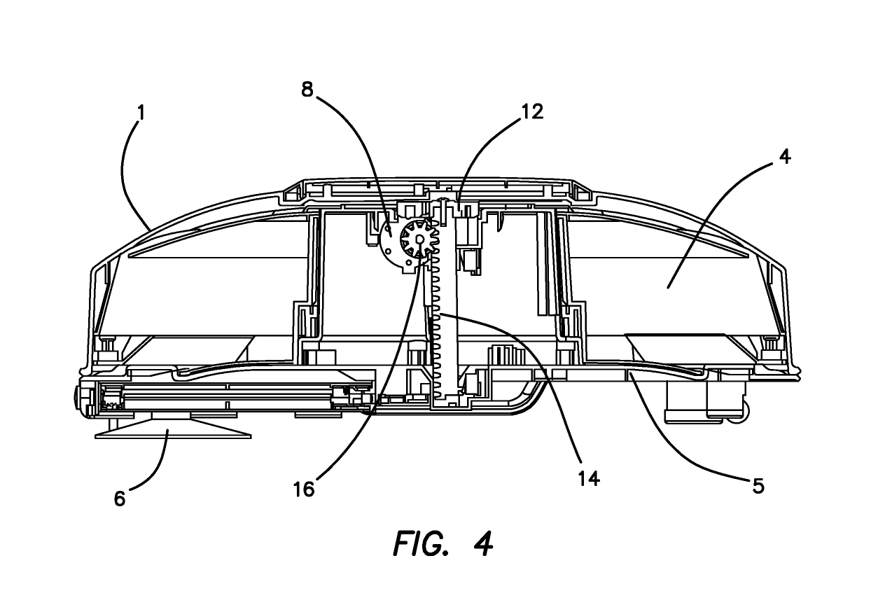

The apparatus further comprises a base 5 which, when combined with the shell 1, form a housing for the internal components of the apparatus 10 that are seen in FIGS. 2 and 3. Disposed in the middle of the base 5 is a rotation body or drum 2. The rotation body 2 is configured to spin or rotate in both a clockwise and counterclockwise direction and may be in the configuration of a flywheel, spindle, or wheel. Coupled to the rotation body 2 is a cover or tarpaulin 4. Specifically, the cover 4 is coupled around the circumference of the rotation body 2, thus disposing the rotation body 2 in the center of the cover 4. The cover 4 may be comprised of canvas, plastic, nylon or polyester composites, or any other material that is known to be sufficiently malleable and weather resistant. Also disposed within the apparatus 10 and coupled to the rotation body 2 at one end and to an inside surface of the shell 1 is a lift rod 3. The lift rod 3 is seen as being coupled to a top portion of the rotation body 2, however this is meant to be for illustrative purposes only. For example, in a further embodiment the lift rod 3 may be located or disposed on other portions of the base 5 and within the shell 1. In one embodiment, the lift rod 3 is a mechanical, pneumatic, or other telescopic device which increases its height when activated. An electric motor 8 is further coupled to both the rotation body 2 and the lift rod 3. The motor 8 may further comprise a control system which itself comprises additional electronic components including but not limited to an ECU or microcontroller, a memory chip, one or more antennas for wireless communication with an outside device, and a rechargeable battery which is coupled to the solar panel 7 disposed on the outside of the shell 1. On the outside surface of the base 5, a plurality of suction cups 6 are disposed. Each suction cup 6 is sized and shaped to provide a removable means for coupling the apparatus 10 to the outside surface of an automobile.

To use the apparatus 10, the user places the apparatus 10 on an automobile, preferably on the roof of the automobile or another portion which is elevated with respect to the rest of the automobile. The user presses the apparatus 10 downward against the automobile thus engaging the plurality of suction cups 6 coupled to the base 5 with the surface of the automobile, thus locking the apparatus 10 in a stable, yet removable position that is preferably centered or disposed over the center of the automobile.

The user then activates the apparatus 10 by actuating a button or switch disposed on the shell 1 of the apparatus 10. Once activated, the lift rod 3 under the influence of the motor 8 and control system drive or expand the lift rod 3 which raises the shell 1 upward off the base 5 and exposing the cover 4 disposed therein. The motor 8 and control system then engages the rotating body 2 which then begins rotating or spinning in a first direction. The cover 4 coupled to the rotating body 2 is then pulled in the same direction as the spinning rotation body 2 and begins to spin out from under the shell 1 under the centripetal force imparted to it from the rotation body 2. The rotation body 2 continues to rotate and the cover 4 continues to spin out further and further from the apparatus 10 until the cover 4 substantially covers a majority of the automobile. The rotation body 2 may rotate for a predetermined time as maintained by the control system or alternatively, the rotation body 2 may rotated for as long as the user interacts or activates an accompanying app on their mobile phone or other device as is further detailed below. With the cover 4 fully extended, the user may secure the cover to or around the automobile using traditional means such as bungie cords, ties, or the like. Finally, under the influence of the motor 8 and control system, the lift rod 3 is the lowered or contracted, thus bringing the shell 1 back down against the base 5. With the cover 4 fully covering the automobile, the user may leave the automobile with the apparatus 10 in place.

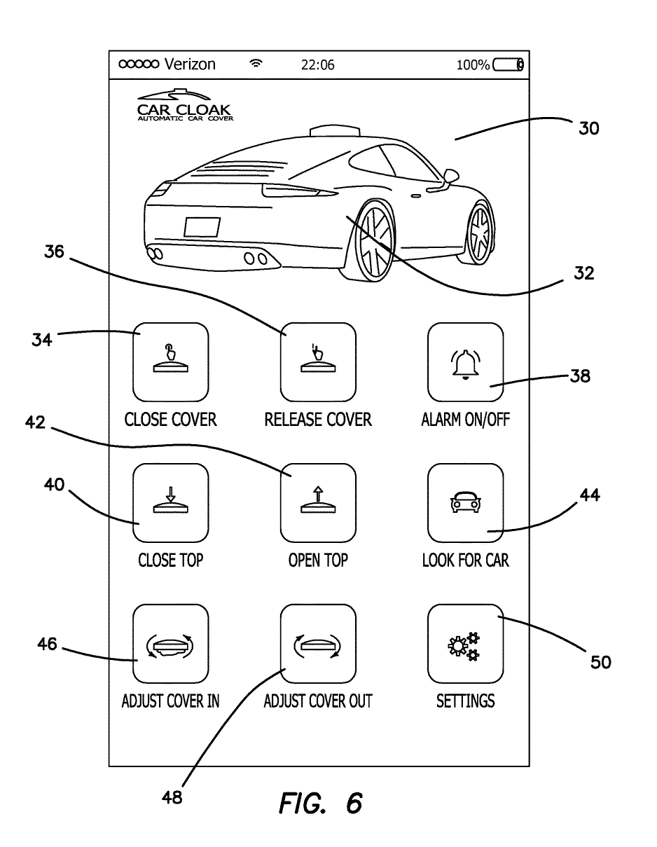

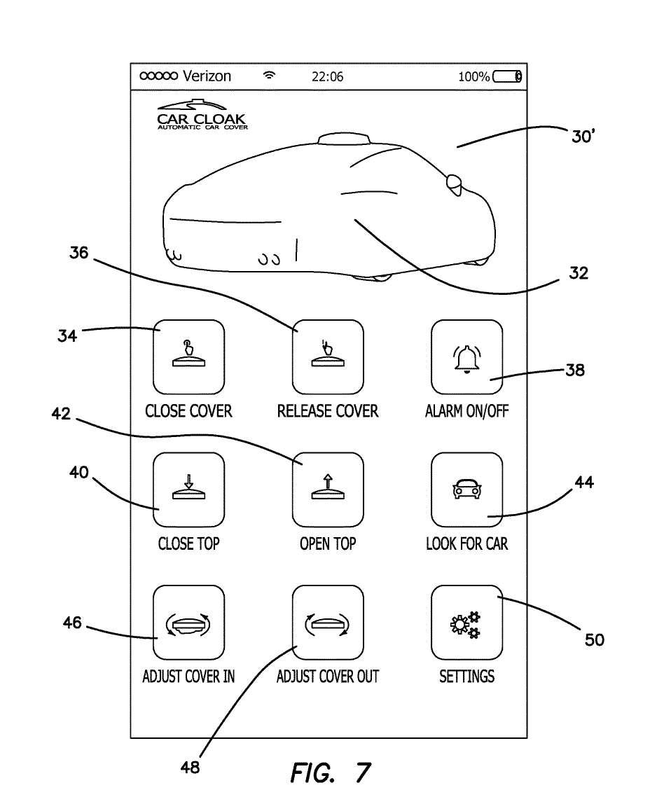

Alternatively, the user may activate the apparatus 10 by activating an app located on a mobile phone or other mobile device. FIGS. 6 and 7 show two exemplary screens 30 and 30′ within the app allowing the user to interact and control the apparatus. In one particular embodiment, the screens 30, 30′ comprise an apparatus status indicator 32 which indicates the current status of the position of the cover 4 over the user's vehicle. Specifically, if the cover 4 has not been deployed and is still currently contained within the shell 1, a graphical representation of the user's car is shown without the cover 4 disposed over it as is seen in FIG. 6. However if the cover 4 has been disposed over and is currently covering the user's vehicle, the status indicator 32 will change and show a graphical representation of the user's vehicle with the cover draped or disposed over it as is seen in FIG. 7.

As is also seen in FIGS. 6 and 7, the app also comprises a plurality of buttons or activation points 34-50, each button 34-50 being directed to a different to a different feature or action. The close cover button 34 will for example will begin to draw in and wind up the cover 4 when actuated, while the release cover button 36 will deploy or otherwise initiate the car covering process detailed above. Additional buttons such as the close top button 40 and the open top button 42 will activate specific components of the apparatus 10 such as raising or lowering the lift rod 3, respectively. Similarly, the adjust cover in button 46 and the adjust cover out button 48 specifically activate only the rotation body 2 portion of the apparatus 10 to either manually draw in or spool out the cover 4, respectively. The app displayed on screens 30 and 30′ also comprises a number of activation means for a suite of features not related to the specific task of covering or uncovering a vehicle. For example, the alarm button 38 when actuated will activate an audio, visual, or other alarm disposed on or within the apparatus 10 to notify others in the surrounding area that the user feels threatened or otherwise requires assistance. Alternatively, the look for car button 44 when actuated will activate a light or audio signal that emanates from the apparatus 10, allowing the user to visually or audibly locate the vehicle to which the apparatus 10 is coupled to. Finally, a settings button 50 allows the user to adjust or change any number of settings associated with the use of the apparatus 10 or the app itself, including cosmetic or connection settings.

It is important to note that the depictions seen in FIGS. 6 and 7, specifically the organization of the buttons 34-50 within a 3×3 grid as is seen, is meant to be for illustrative purposes only. Fewer, additional, or different buttons related to different features other than what has been specifically described above may be used without departing from the original spirit and scope of the invention. Similarly, the buttons 34-50 themselves may be organized or distributed about the screens 30, 30′ in a different format or pattern than what is explicitly shown in the specific placement shown in FIGS. 6 and 7.

While the apparatus 10 is activated, the light disposed on the shell 1 illuminates thus notifying the user that the apparatus 10 is active. The light may be illuminated continuously while the apparatus 10 is in use or alternatively, operate in a pattern, flash, or other strobing pattern. Additionally, the user may activate the light without activating the entire apparatus 10 through the wireless connection established between the apparatus 10 and their smart device. For example, a user wishing to locate their vehicle in a crowded parking lot or distinguish their vehicle from other similar looking vehicles may use their smart device to activate the light via the corresponding app seen in FIGS. 6 and 7, thus signaling the specific location of the user's vehicle. In a further embodiment, the apparatus 10 may emit an alarm or other audible sound to further indicate the vehicle's location relative to the user.

To uncover the automobile, the user first unclips or unties the bungie cords and/or ties, thus releasing the cover 4 from the body of the automobile. The user then reactivates the apparatus, again through either an app located on their mobile device, or by directly actuating a button or switch disposed on the shell 1. The apparatus 10 then repeats the above process in reverse by first raising or expanding the lift rod 3 and raising the shell 1 up off of the exposed cover 4 and base 5. The rotation body 2 is then rotated or spun in a second direction, the second direction being in the opposite orientation relative to the first direction. As the rotation body 2 is spun in the second direction, the cover 4 begins to be pulled inward towards the apparatus 10 while simultaneously wrapping itself around the rotation body 2. The rotation body 2 continues to rotate until the entire cover 4 is brought back under the shell 1. The lift rod 3 is then lowered or contracted and the shell 1 is then brought back down over the cover 4 and against the base 5. If a portion of the cover 4 remains outside of the apparatus 10 when the shell 1 is lowered, the downward progress of the shell 1 is stopped and the rotation body 2 is spun in the second direction again, thereby bringing the errant portion of the cover 4 within the apparatus 10. Alternatively, the user may control rotation body 2 at any point during the retraction process through a manual manipulation of the app on their mobile device using the adjust cover in or adjust cover out buttons 46, 48. The apparatus 10 will repeat the steps of alternately lowering the shell 1 and rotating the rotation body 2 in the second direction until the cover 4 is completely brought within the apparatus 10 and sufficiently wrapped around the rotation body 2. At the end of the retraction process, the shell 1 is brought fully down against the base 5, thus enclosing the cover 4 within the shell 1. The apparatus 10 is then removed from the automobile by sliding or lifting the apparatus 10 from the surface of the automobile and disengaging the suction cups 6 disposed on the apparatus 10. The user may then pick up and store the apparatus 10 in their trunk or other storage area until further use is needed.

An alternative embodiment for lifting the shell 1 of the apparatus may be seen in FIG. 4. Here, the apparatus 10 comprises a rack spline 14 that is coupled to the base 5 and to the shell 1 by a shell bracket 12. In this embodiment the motor is disposed at the top of the rack spline 14 near the inner surface of the shell 1. Coupled to the motor 8 is a lift gear 16 which is in turn engaged to a plurality of teeth disposed on the rack spline 14. When the motor 8 is activated, the motor 8 rotates the lift gear 16 in a first direction which in turn sends the rack spline 14 in an upward direction and lifts the shell 1 up off of the base 5 and exposes the cover 4. When the shell 1 is to be lowered back onto the base 5, the motor 8 rotates the lift gear 16 in an opposing direction, thus reversing the direction of the rack spline 14 and lowering the shell 1.

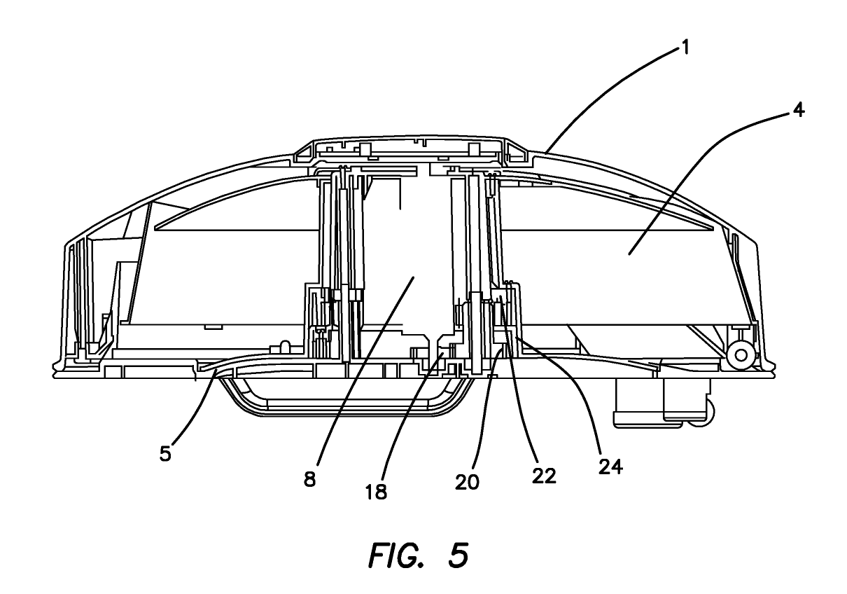

An alternative embodiment of the rotation body 2 may be seen in FIG. 5. In this embodiment, the motor 8 is disposed substantially in the center of the apparatus 10 and is coupled at its lower portion to a first gear 18. The first gear 18 is engaged with a double gear 20 that is turn coupled to a gear ring 22. Also in this embodiment, the cover 4 is coupled to a cover bracket 24 that is itself coupled to an opposing side of the gear ring 22. When the motor 8 is activated, the motor 8 rotates the first gear 18 in a first direction which in turn rotates the double gear 20 in a direction which opposes the first direction of the first gear 18. The rotating double gear 20 and gear ring 22 then cooperate to rotate the cover bracket 24 which in turn drags or rotates the cover 4 that is coupled to it in the same direction and thus deploying the cover 4 from the apparatus 10. When the cover 4 is to be retracted back into the apparatus 10, the motor 8 rotates the first gear 18 in an opposing direction, thus reversing the direction of the double gear 20 and cover bracket 24 and thereby retracting or wrapping the cover 4 about the rotation body 2.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. An apparatus for covering a vehicle comprising:
a base;
a rotation body coupled to the base;
a lift rod coupled to the base;
a motor coupled to the rotation body;
a cover coupled to the rotation body; and
a shell disposed over the base and coupled to the lift rod.

2. The apparatus of claim 1 wherein the lift rod comprises a rack spline.

3. The apparatus of claim 2 further comprising a lift gear coupled to the motor, wherein the lift gear is engaged with the rack spline.

4. The apparatus of claim 1 further comprising a plurality of suction cups disposed on the base and configured to be removably adhered to a surface of the vehicle.

5. The apparatus of claim 1 wherein the rotation body comprises a rotating cylinder and a control system.

6. The apparatus of claim 1 wherein the shell comprises a solar panel disposed in a surface of the shell.

7. The apparatus of claim 1 wherein the shell comprises a liquid crystal display panel disposed in a surface of the shell.

8. The apparatus of claim 1 further comprising:
a first gear coupled to the motor;
a double gear engaged with the first gear; and
a gear ring coupled to the double gear,
wherein the cover is coupled to the gear ring.

9. The apparatus of claim 1 wherein the lift rod is a telescopic lift rod.

10. The apparatus of claim 1 wherein the apparatus is configured to be operated via a mobile device.

11. The apparatus of claim 1 further comprises:
a light coupled to the shell; or
an alarm disposed on the shell.

12. A method for automatically disposing a cover over a vehicle comprising:
removably coupling an apparatus onto the surface of a vehicle, wherein the apparatus comprise a cover disposed between a shell and a base of the apparatus;
actuating the apparatus to raise the shell off of the base;
rotating a rotation body disposed underneath the shell in a first direction, the rotation body being coupled to the cover;
disposing the cover over the surface of the vehicle; and
securing the cover in place over the vehicle.

13. The method of claim 12 wherein removably coupling an apparatus onto the surface of a vehicle comprises removably adhering the apparatus to the surface of the vehicle via a plurality of suction cups.

14. The method of claim 12 wherein actuating the apparatus to raise the shell off of the base comprises activating a motor to raise a telescopic lift rod disposed between the shell and the base.

15. The method of claim 12 wherein actuating the apparatus to raise the shell off of the base comprises activating a motor that is engaged to a rack spline via a lift gear to raise the rack spline disposed between the shell and the base.

16. The method of claim 12 further comprising:
rotating the rotation body in a second direction;
drawing the cover about the rotation body and retracting the cover underneath the shell; and
actuating the apparatus to lower the shell onto the base.

17. The method of claim 12 wherein actuating the apparatus to raise the shell off of the base and rotating a rotation body disposed underneath the shell in a first direction comprises remotely sending an actuation command to the apparatus from a mobile device.

18. The method of claim 12 further comprising recharging the apparatus via a solar panel disposed in a surface of the shell.

19. The method of claim 12 further comprising emitting an audio or visual signal from the apparatus by remotely sending an actuation command to the apparatus from a mobile device.

20. The method of claim 12 wherein rotating a rotation body disposed underneath the shell in a first direction comprises activating a motor to rotate a plurality of gears which in turn rotates a cover bracket coupled to the cover in the first direction.
